(19) United States
(12) Patent Application Publication
(10) Pub. No.: US 2026/0042192 A1
(43) Pub. Date: Feb. 12, 2026

(54) IMPACT TOOL AND ELECTRIC TOOL

(71) Applicant: Koki Holdings Co., Ltd., Tokyo (JP)

(72) Inventors: Kenta HARADA, Ibaraki (JP); Tomomasa NISHIKAWA, Ibaraki (JP); Satoru MATSUNO, Ibaraki (JP)

(73) Assignee: Koki Holdings Co., Ltd., Tokyo (JP)

(21) Appl. No.: 19/102,408

(22) PCT Filed: Sep. 7, 2023
(86) PCT No.: PCT/JP2023/032643

§ 371 Date: Feb. 9, 2025

(30) Foreign Application Priority Data
Sep. 30, 2022 (JP) 2022-158342

(51) Int. Cl. B25B 21/02; B25B 23/00; H02P 23/14

(52) U.S. Cl. CPC B25B 21/02; B25B 23/0064; H02P 23/14

(57) ABSTRACT

Provided is an impact tool capable of stopping or decelerating a motor even if seating has occurred before impacting starts. An electric tool, which is an impact tool, includes: a motor; an impact mechanism driven by the motor; a current measuring means for measuring a motor current; a rotation speed measuring means for detecting a motor rotation speed; and a control unit for controlling the motor. The control unit includes a seating determination mode configured to determine whether a screw is seated, in accordance with the measured motor current and motor rotation speed, at any time point before or after impacting by the impact mechanism is started in a screw tightening operation having multiple different work conditions, and to stop or decelerate the motor after it has been determined that the screw is seated.

### TECHNICAL FIELD

The present invention relates to an impact tool and an electric tool.

### DESCRIPTION OF RELATED ART

The following Patent Literature 1 discloses that seating determination is performed based on an electric current.

### RELATED ART

### Patent Literature

Patent Literature 1: Japanese Patent No. 6984742

### SUMMARY

### Technical Problem

In the technology of Patent Literature 1, if seating had occurred before impacting by an impact mechanism started, the motor was unable to be stopped or decelerated. In addition, since seating determination was performed based on the electric current, there was a risk of over-tightening or under-tightening, which resulted in poor workability.

The present invention aims to solve at least one of the following problems 1 to 3. Problem 1: To provide an impact tool capable of stopping or decelerating a motor even if seating has occurred before impacting starts. Problem 2: To provide an electric tool with good workability. Problem 3:. To provide an electric tool capable of being controlled based on the amount of machining.

### Solution to the Problem

An embodiment of the present invention is an impact tool. The impact tool includes a motor, an impact mechanism driven by the motor, a current measuring means for measuring a current of the motor, a rotation speed measuring means for detecting a rotation speed of the motor, and a control unit for controlling the motor. The control unit includes a seating determination mode configured to determine whether a screw is seated, in accordance with the current of the motor and the rotation speed of the motor that are measured, at any time point before or after impacting by the impact mechanism is started in a screw tightening operation having multiple different work conditions, and to stop or decelerate the motor after it has been determined that the screw is seated.

Another embodiment of the present invention is an electric tool. The electric tool includes a motor and a control unit for controlling the motor. The control unit includes a screw tightening depth control mode configured to estimate a screw tightening depth into a mating material according to a measured state quantity of the electric tool, and to control the motor according to the screw tightening depth estimated and a setting value set by a setting unit. The setting unit is configured to be able to set multiple screw tightening depths, including a first screw tightening depth before a screw is seated on a mating material and a second screw tightening depth different from the first screw tightening depth, as the setting values.

Another embodiment of the present invention is an electric tool. The electric tool includes a motor, a current measuring means for measuring a current of the motor, a rotation speed measuring means for detecting a rotation speed of the motor, and a control unit for controlling the motor. The control unit includes a machining amount estimation mode configured to estimate a machining amount, which is an amount of irreversible machining of a mating material, according to the current of the motor and the rotation speed of the motor that are measured, and to control the motor according to the machining amount estimated.

### Effects

According to the present invention, at least one of the above problems 1 to 3 can be solved.

### BRIEF DESCRIPTION OF THE DRAWINGS

FIG. 1 is a right side view of an electric tool 1 according to a first embodiment of the present invention.

FIG. 2 is a right side cross-sectional view of the electric tool 1.

FIG. 3 is a circuit block diagram of the electric tool 1.

FIG. 4 is a functional block diagram of the control unit 40 of FIG. 3.

FIG. 5 is a control flow chart of the control unit 40 in a stopped state.

FIG. 6 is a control flow chart of the control unit 40 in an operating state.

FIGS. 7(A) to 7(F) are schematic cross-sectional views showing the progress of a screw tightening operation on a mating material. (G) is a graph showing the changes over time in a current of a motor 20, a rotation speed of the motor 20, and the screw head floating amount during the screw tightening operation shown in FIGS. 7(A) to 7(F).

FIG. 8 is a diagram showing the correlation between the current and the rotation speed of the motor 20 in the electric tool 1 and the screw head floating amount.

FIG. 9 is a conceptual diagram showing the structure of a neural network that estimates the screw head floating amount in the electric tool 1.

FIG. 10 is a graph similar to FIG. 7(G), which is a graph showing that time series data of the current and the rotation speed of the motor 20 from time t−n to time t is used as an input to estimate the screw head floating amount at time t.

FIG. 11 is a graph in which estimated values of the screw head floating amount are added to the graph of FIG. 10.

FIG. 12 is a functional block diagram of a control unit 140 of an electric tool according to a second embodiment of the present invention.

FIG. 13 is a control flow chart of the control unit 140 in an operating state.

FIG. 14 is a flow chart of the machining amount calculation in the control unit 140.

FIG. 15 is a conceptual diagram showing an example of a table used for estimating the machining amount before the start of impacting.

FIG. 16 is a conceptual diagram showing an example of a table used for estimating the machining amount after the start of impacting.

FIG. 17 is a graph showing the relationship between the product of the current and the rotation speed of the motor 20 and the screw head floating amount for two types of screws.

FIG. 18 is a graph showing the average curve of the data for the two types of screws in FIG. 17.

### DESCRIPTION OF EMBODIMENTS

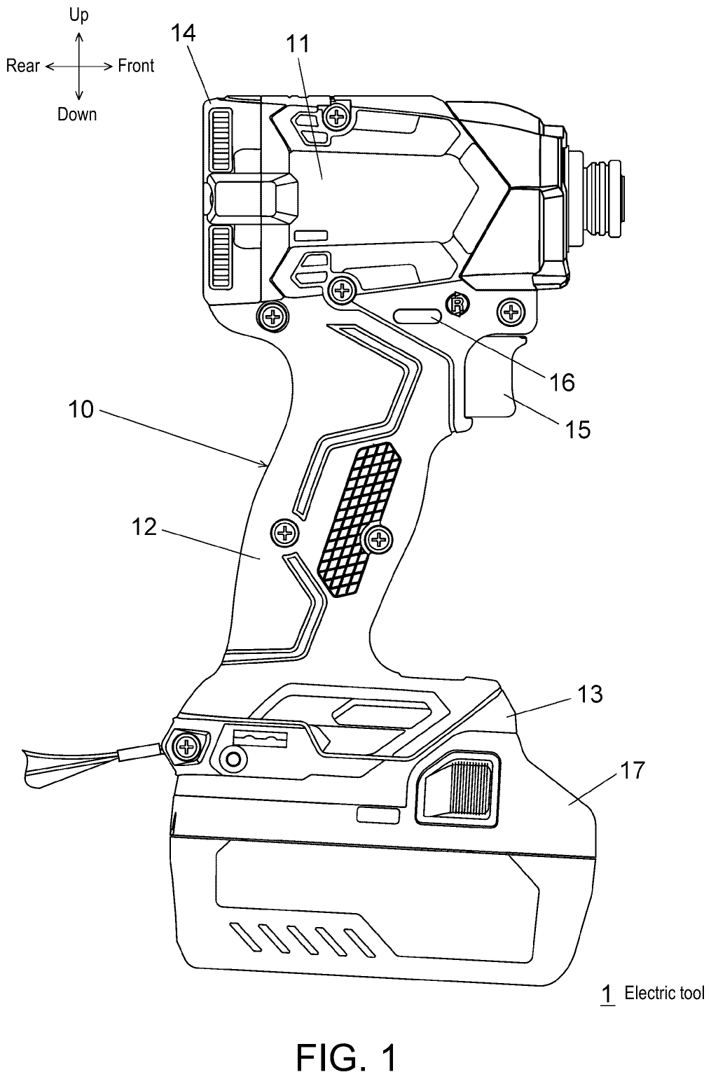

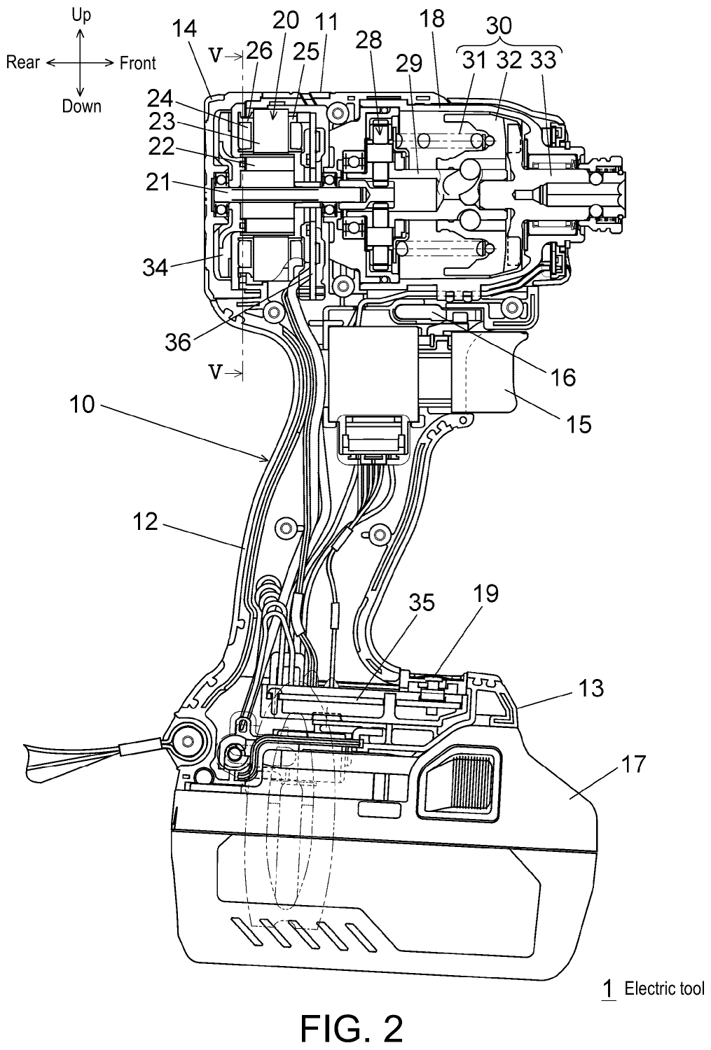

(First embodiment) FIGS. 1 to 11 relate to an electric tool 1 according to a first embodiment of the present invention. The electric tool 1 is a work machine, and more specifically, an impact tool (impact driver). As shown in FIGS. 1 and 2, a front-rear direction and an up-down direction of the electric tool 1 are defined as being perpendicular to each other. The front-rear direction is a direction parallel to a motor shaft 21.

As shown in FIGS. 1 and 2, the electric tool 1 includes a housing 10. The housing 10 is, for example, a resin molded body having a two-piece structure consisting of a left part and a right part. The housing 10 includes a motor accommodating unit 11, a handle unit 12, and a battery pack mounting unit 13.

The motor accommodating unit 11 is a cylindrical unit of which central axis is substantially parallel to the front-rear direction. The handle unit 12 has an upper end connected to a middle unit of the motor accommodating unit 11 in the front-rear direction and extends downward from the middle unit. The battery pack mounting unit 13 is provided at a lower end of the handle unit 12, and a battery pack 17 can be detachably attached thereto. The electric tool 1 operates using power from the battery pack 17.

The electric tool 1 includes a tail cover 14 that is connected to an opening on the rear side of the motor accommodating unit 11 and covers the opening. The tail cover 14 is fixed to the motor accommodating unit 11 by screws or the like.

The electric tool 1 includes a hammer case 18 connected to the front unit of the motor accommodating unit 11. The hammer case 18 is made of, for example, metal, and is held in the motor accommodating unit 11 and extends forward from the motor accommodating unit 11.

The electric tool 1 includes a trigger switch 15 at the upper end of the handle unit 12 for a user to switch between drive and a stop of a motor 20. The electric tool 1 includes a forward/reverse switching switch 16 near the boundary unit between the motor accommodating unit 11 and the handle unit 12 for the user to switch between forward rotation and reverse rotation of the motor 20.

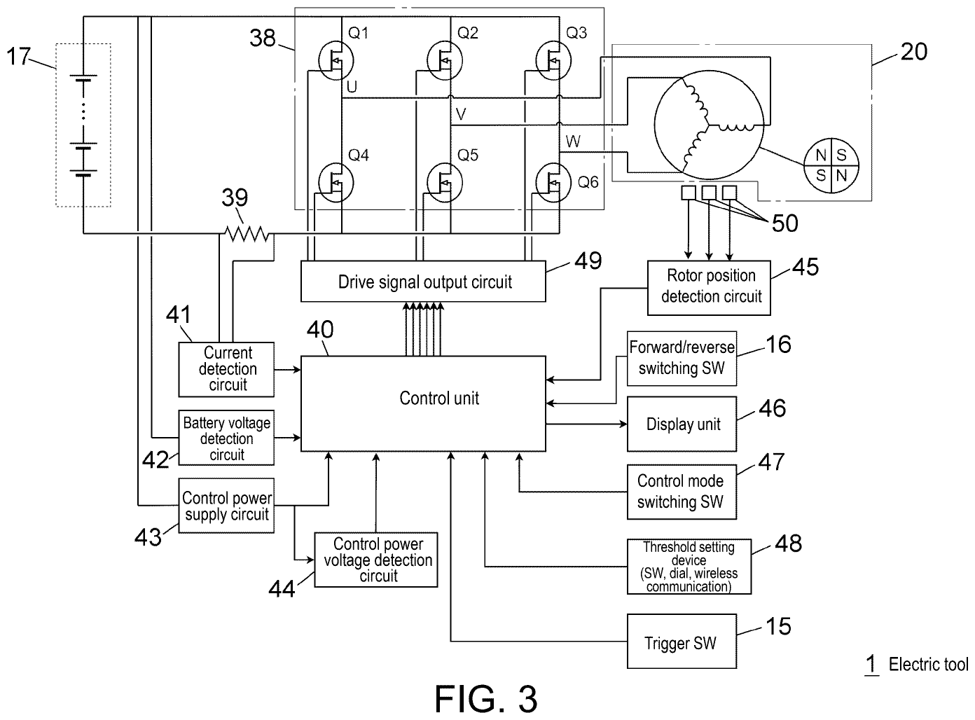

The electric tool 1 includes a first control board 35 in the battery pack mounting unit 13. The first control board 35 is equipped with a control unit 40 (FIG. 3) such as a microcomputer that controls the drive of the motor 20. The electric tool 1 includes an operation panel 19 on the front upper surface of the battery pack mounting unit 13. The operation panel 19 includes a display unit 46, a control mode switching switch 47, and a threshold setting device 48 shown in FIG. 3.

The work machine 1 includes the motor 20, a deceleration mechanism 28, a spindle 29, a rotary impact mechanism 30 as an impact mechanism, and a fan 34 on the inner side of the motor accommodating unit 11 and the hammer case 18.

The motor 20 is an inner rotor type brushless motor, and includes the motor shaft 21 that is parallel to the front-rear direction. The motor 20 includes a rotor 22, a stator core 23, a stator coil 24, a front insulator 25, and a rear insulator 26.

The rotor 22 is provided around the motor shaft 21 and rotates integrally with the motor shaft 21. The stator core 23, the stator coil 24, the front insulator 25, and the rear insulator 26 form a stator of the electric tool 1.

The stator core 23 is provided radially outside the rotor 22. The stator coil 24 is provided on the stator core 23. The front insulator 25 is provided in front of the stator core 23. The rear insulator 26 is provided at the rear of the stator core 23. The front insulator 25 and the rear insulator 26 are, for example, resin molded bodies, and provide insulation between the stator core 23 and the stator coil 24.

A second control board 36 is attached to the front of the front insulator 25. The second control board 36 is equipped with a magnetic sensor 50 (FIG. 3) such as a Hall IC for detecting the rotational position of the motor 20 and an inverter circuit 38 (FIG. 3) for supplying a drive current to the stator coil 24.

The deceleration mechanism 28 decelerates the rotation of the motor 20 and transmits the rotation to the spindle 29. The spindle 29 drives the rotary impact mechanism 30. The rotary impact mechanism 30 is an output unit of the electric tool 1 and is driven by the motor 20.

The rotary impact mechanism 30 includes a spring 31, a hammer 32, and an anvil 33. The anvil 33 holds a tool tip such as a bit (not shown). The hammer 32 is in cam engagement with the spindle 29 and is biased forward by the spring 31. The hammer 32 driven by the spindle 29 rotates and impacts the anvil 33. The configuration and operation of the rotary impact mechanism 30 are well known and therefore will not be described in further detail.

The fan 34 is attached to the motor shaft 21 behind the rotor 22, rotates integrally with the motor shaft 21, and generates cooling air for cooling the motor 20 and the like.

FIG. 3 is a circuit block diagram of the electric tool 1. The electric tool 1 includes the inverter circuit 38, a resistor 39, the control unit 40, a current detection circuit 41, a battery voltage detection circuit 42, a control power supply circuit 43, a control power voltage detection circuit 44, a rotor position detection circuit 45, the display unit 46, the control mode switching switch 47, the threshold setting device 48, a drive signal output circuit 49, and the magnetic sensor 50.

The inverter circuit 38 includes six switching elements Q1 to Q6, such as FETs, that are connected in a three-phase bridge. The resistor 39 is provided in the path of a current (hereinafter referred to as the “motor current”) flowing through the motor 20.

The control unit 40 is, for example, a microcomputer (microcontroller) and controls the overall operation of the electric tool 1. The current detection circuit 41 detects the motor current from the voltage of the resistor 39 and transmits the motor current to the control unit 40. The current detection circuit 41 and the resistor 39 constitute a current measuring means.

The battery voltage detection circuit 42 detects an output voltage (hereinafter referred to as “battery voltage”) of the battery pack 17 and transmits the battery voltage to the control unit 40. The control power supply circuit 43 converts the battery voltage into a power voltage for the control unit 40 and the like, and supplies the power voltage to the control unit 40 and the like. The control power voltage detection circuit 44 detects an output voltage of the control power supply circuit 43 and transmits the output voltage to the control unit 40.

The rotor position detection circuit 45 detects a rotational position (rotor rotational position) of the motor 20 based on an output signal from the magnetic sensor 50, and transmits the rotational position to the control unit 40. The control unit 40 detects the rotation speed (hereinafter referred to as “motor rotation speed”) of the motor 20 based on the output signal of the rotor position detection circuit 45. The rotor position detection circuit 45, the magnetic sensor 50, and the control unit 40 constitute a rotation speed measuring means.

The display unit 46 displays the current threshold values (setting values) and the control mode. The control mode switching switch 47 is, for example, a tactile switch, and is an operation unit with which the user switches between enabling and disabling a machining amount control mode, which will be described later. The threshold setting device 48 is a device (setting unit) that sets a threshold value (setting value) in the machining amount control mode, which will be described later. The threshold setting device 48 is, for example, a switch (button) provided on the operation panel 19. Alternatively, the threshold setting device 48 may be a dial provided separately from the operation panel 19, or may be a wireless communication device that receives the threshold value via wireless communication with an external device such as a smartphone.

The drive signal output circuit 49 applies a drive signal, for example a PWM signal, to each of gates of the switching elements Q1 to Q6 of the inverter circuit 38 under the control of the control unit 40. The magnetic sensor 50 outputs a signal corresponding to the rotational position of the motor 20 to the rotor position detection circuit 45.

The control unit 40 controls the on/off of the switching elements Q1 to Q6 via the drive signal output circuit 49 in accordance with the operation of the trigger switch 15, the state of the forward/reverse switching switch 16, whether the machining amount control mode is enabled or disabled, and the threshold value in the machining amount control mode, thereby controlling the drive of the motor 20.

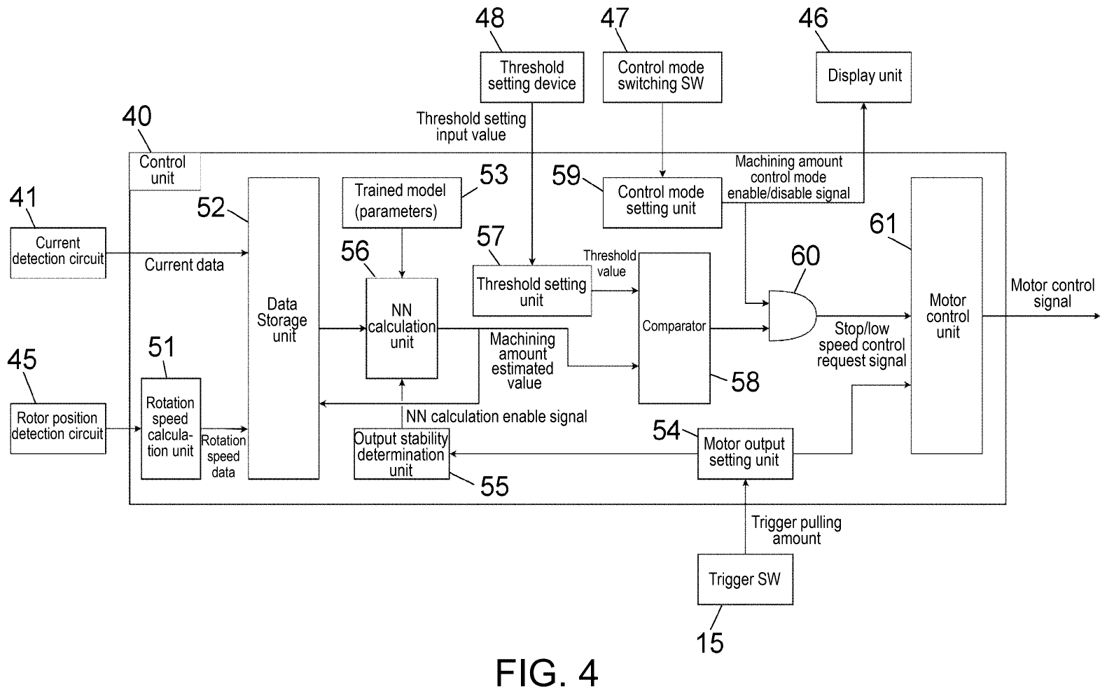

FIG. 4 is a functional block diagram of the control unit 40 of FIG. 3. Each of blocks shown in FIG. 4 is a function of the control unit 40, but does not mean that each of the blocks has actual hardware. In addition, “NN” in the drawings stands for a neural network.

The control unit 40 includes a rotation speed calculation unit 51, a data storage unit 52, a trained model 53, a motor output setting unit 54, an output stability determination unit 55, a neural network calculation unit 56 (hereinafter referred to as “NN calculation unit 56”), a threshold setting unit 57, a comparator 58, a control mode setting unit 59, an AND gate 60, and a motor control unit 61.

The rotation speed calculation unit 51 calculates the motor rotation speed based on a received signal from the rotor position detection circuit 45. In the drawing, “rotation speed” refers to the number of rotations of the motor 20 per unit time (hereinafter “motor rotation speed”), that is, the motor rotation speed.

The data storage unit 52 stores the motor rotation speed calculated by the rotation speed calculation unit 51 and the motor current received from the current detection circuit 41, that is, the measured values of the motor rotation speed and the motor current.

The trained model 53 is a functional block that stores neural network parameters (hereinafter referred to as “NN parameters”) for estimating the machining amount, for example, the screw tightening depth, from time-series data of the motor rotation speed and the motor current. The NN parameters include weights and biases. The NN parameters are generated in advance by machine learning. The machine learning method will be described later.

The motor output setting unit 54 detects the turning on of the trigger switch 15 and transmits the turning on to the output stability determination unit 55. Further, the motor output setting unit 54 transmits an output setting signal corresponding to the pulling amount of the trigger switch 15 to the motor control unit 61.

When a predetermined time has elapsed since the trigger switch 15 was turned on, the output stability determination unit 55 determines that the output of the motor 20 has stabilized, and changes a neural network calculation enable signal (hereinafter referred to as the “NN calculation enable signal”) from a low level (disabled) to a high level (enabled).

When the NN calculation enable signal is at a high level, the NN calculation unit 56 calculates a machining amount estimated value based on the time series data of the motor rotation speed and motor current measurement values stored in the data storage unit 52 and the NN parameters stored in the trained model 53.

The threshold setting unit 57 receives a threshold setting input value from the threshold setting device 48 and outputs a threshold value. The comparator 58 compares the machining amount estimated value with the threshold value, and outputs a low level signal if the machining amount estimated value is equal to or less than the threshold value, or outputs a high level signal if the machining amount estimated value exceeds the threshold value.

The control mode setting unit 59 detects the operation of the control mode switching switch 47, and outputs a machining amount control mode enable/disable signal. The machining amount control mode enable/disable signal is at a high level when the machining amount control mode is enabled, and is at a low level when the machining amount control mode is disabled. The display unit 46 displays whether the machining amount control mode is enabled or disabled.

The AND gate 60 outputs a signal which is the logical AND of the machining amount control mode enable/disable signal and the output signal of the comparator 58. In other words, the AND gate 60 passes the output signal of the comparator 58 to the motor control unit 61 when the machining amount control mode enable/disable signal is at a high level (when the machining amount control mode is enabled).

The output signal of the AND gate 60 being at a high level means that the machining amount control mode is enabled and the machining amount estimated value exceeds the threshold value, and means that a stop/low speed control request signal is being output to the motor control unit 61. The output signal of the AND gate 60 being at a low level means that the machining amount control mode is disabled and/or the machining amount estimated value is equal to or less than the threshold value, and means that the stop/low speed control request signal is not output to the motor control unit 61.

The motor control unit 61 outputs a motor control signal corresponding to the output setting signal from the motor output setting unit 54 to the drive signal output circuit 49 (FIG. 3). When the stop/low speed control request signal is input, that is, when the stop/low speed control request signal is at a high level, the motor control unit 61 outputs a motor control signal for performing stop/low speed control on the motor 20 to the drive signal output circuit 49 (FIG. 3), regardless of the output setting signal from the motor output setting unit 54.

The stop/low speed control is control for stopping the motor 20 or control for decelerating the motor 20 to rotate at a low speed. The control for stopping the motor 20 may involve braking the motor 20, or may involve allowing the motor 20 to naturally decelerate without applying the brakes. In this manner, the machining amount control mode is a mode in which the motor 20 is stopped/controlled to a low speed when the machining amount estimated value exceeds the threshold value. The machining amount control mode corresponds to a screw tightening depth control mode and a machining amount estimation mode.

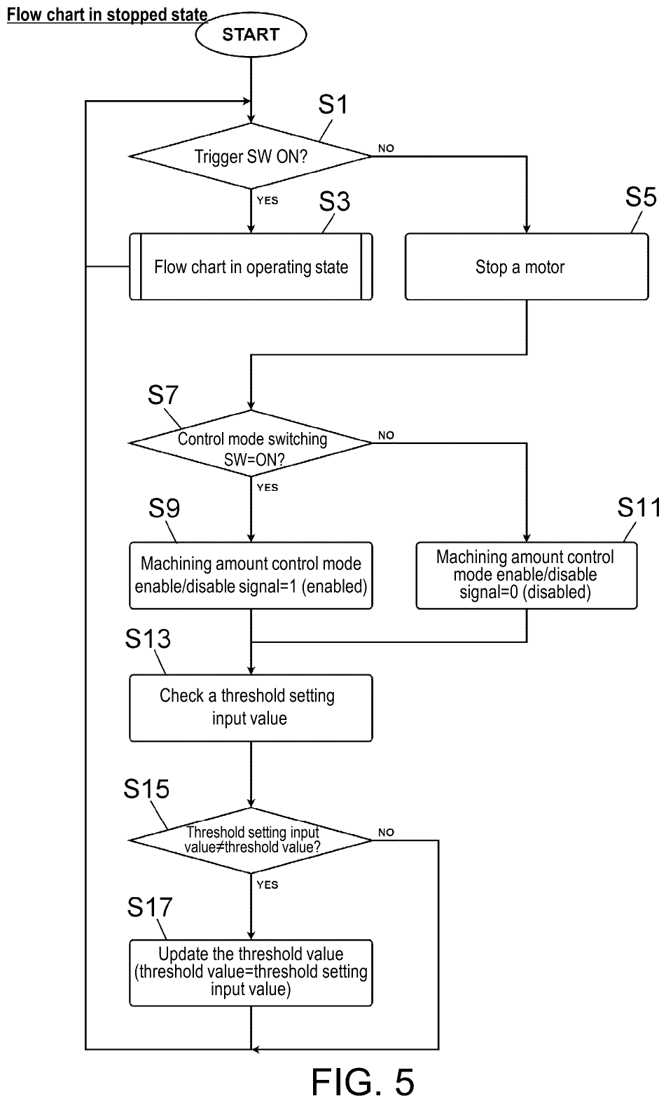

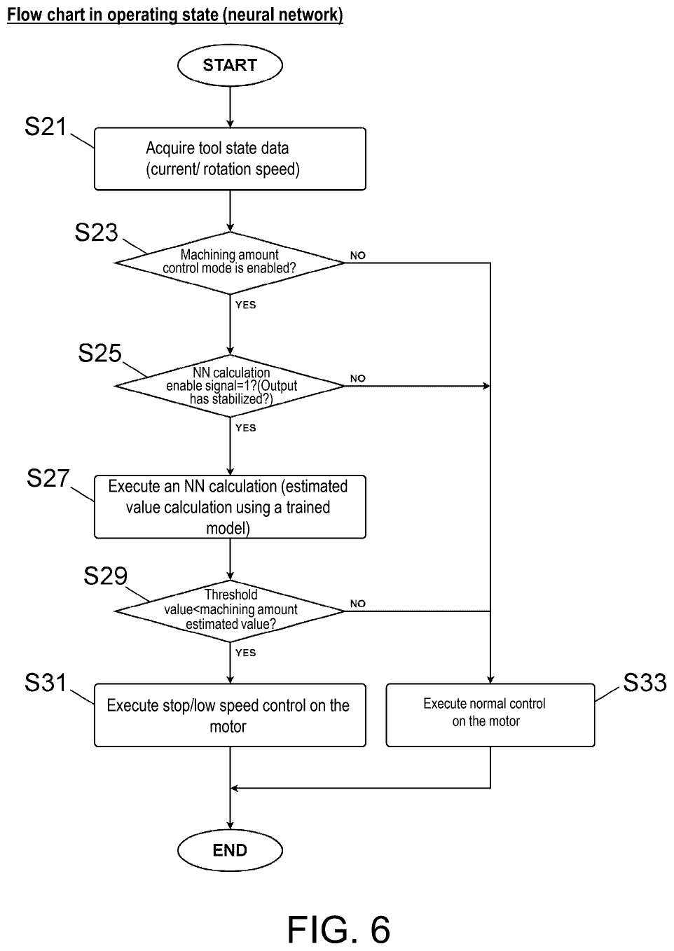

FIG. 5 is a control flow chart of the control unit 40 in a stopped state. When the trigger switch 15 is on (YES in S1), the control unit 40 proceeds to a flow chart for a operating state shown in FIG. 6 (S3). When the trigger switch 15 is off (NO in S1), the control unit 40 stops the motor 20 (S5).

When the control mode switching switch 47 is on (YES in S7), the control unit 40 sets the machining amount control mode enable/disable signal to a high level (enabled) (S9). When the control mode switching switch 47 is off (NO in S7), the control unit 40 sets the machining amount control mode enable/disable signal to a low level (disabled) (S11).

The control unit 40 checks the threshold setting input value from the threshold setting device 48 (S13). If the threshold setting input value does not match the current threshold value (YES in S15), the control unit 40 updates the threshold value (substitutes the threshold setting input value for the threshold value) (S17) and returns to S1. If the threshold setting input value matches the current threshold value (NO in S15), the control unit 40 returns to S1.

FIG. 6 is a control flow chart of the control unit 40 in an operating state. The control unit 40 acquires the motor current and the motor rotation speed as tool state data (S21). When the machining amount control mode is enabled (YES in S23), and the NN calculation enable signal is at a high level (YES in S25), the control unit 40 executes a neural network calculation (hereinafter referred to as “NN calculation”) and derives a machining amount estimated value using the trained model 53 (S27).

If the machining amount estimated value exceeds the threshold value (YES in S29), the control unit 40 performs stop/low speed control on the motor 20 (S31). If the machining amount estimated value does not exceed the threshold value (NO in S29), the control unit 40 performs normal control on the motor 20, that is, controls the rotation speed according to the pulling amount of the trigger switch 15 (S33).

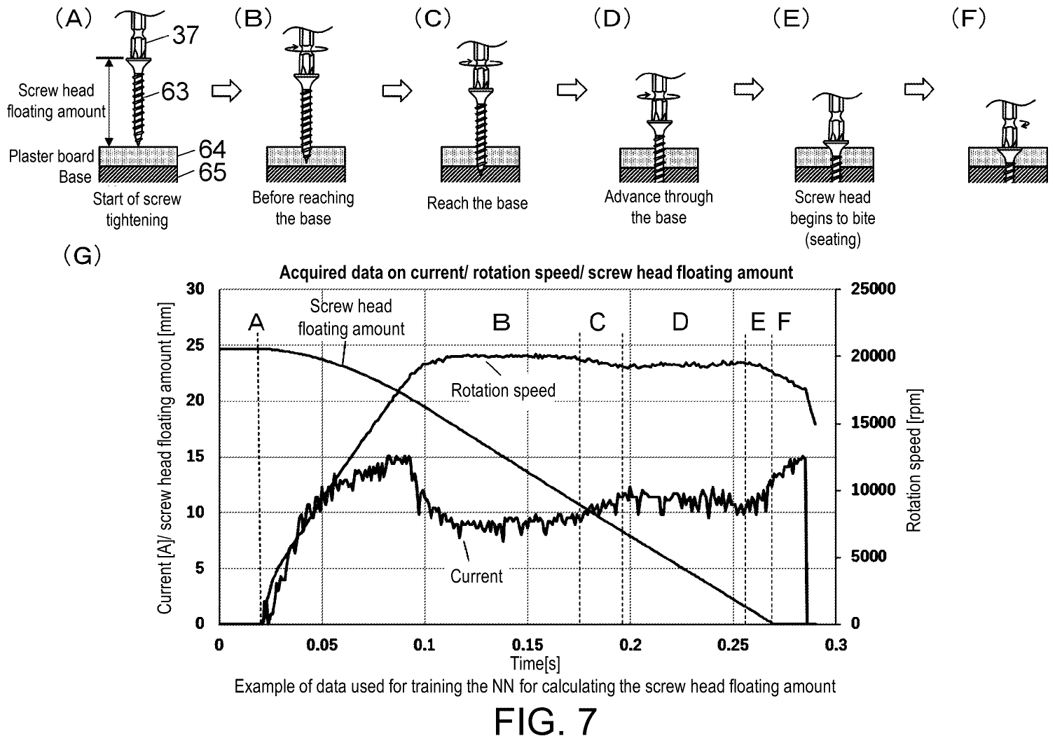

In the case of a screw tightening tool such as the electric tool 1, the machining amount is expressed by the screw tightening depth (the length that the tip of the screw bites into the mating material) and a screw head floating amount shown in FIG. 7(A) (the distance from the surface of the mating material to the head of the screw until the top of the screw head is flush with the surface of the mating material). When the machining amount is the screw head floating amount, the smaller the machining amount, the more the machining has progressed, so the direction of the inequality sign in the determination of S29 is reversed. That is, the control unit 40 performs stop/low speed control on the motor 20 when the machining amount estimated value (estimated value of the screw head floating amount) is less than the threshold value, and performs normal control on the motor 20 when the machining amount estimated value (estimated value of the screw head floating amount) is equal to or greater than the threshold value. The estimated value of the screw tightening depth may be calculated by subtracting the current estimated value of the screw head floating amount from the initially derived estimated value of the screw head floating amount.

When the screw is, for example, a wood screw, drilling a hole in the mating material is involved, so the screw tightening depth and the screw head floating amount are examples of the amount of irreversible machining on the mating material. On the other hand, for example, the mutual fastening of a bolt and a nut is reversible machining since drilling a hole is not involved.

If the machining amount control mode is not enabled (NO in S23), or if the NN calculation enable signal is at a low level (NO in S25), the control unit 40 performs normal control on the motor 20 (S33). When the NN calculation enable signal is at a low level, since the output of the motor 20 is not stable before a predetermined time has elapsed since the trigger switch 15 was turned on, and there is a risk of erroneous determination due to a starting current, etc., the process does not proceed to the NN calculation (S27).

FIGS. 7(A) to 7(F) are schematic cross-sectional views showing the progress of a screw tightening operation on a mating material. FIG. 7(A) shows the state at the start of screw tightening, in which a bit 37 of the electric tool 1 is engaged with a screw 63 and the screw 63 is inserted into the surface of a plaster board 64. FIGS. 7(B) to 7(E) show the states during the screw tightening. FIG. 7(B) shows the state before the tip of the screw 63 reaches a base 65. FIG. 7(C) shows the state when the tip of the screw 63 reaches the base 65. FIG. 7(D) shows the state where the tip of the screw 63 advances through the base 65. FIG. 7(E) shows the seated state, where the bottom end of the head of the screw 63 (the bottom end of the tapered unit) comes into contact with the surface of the plaster board 64 and begins to bite into the surface. FIG. 7(F) shows a state in which the head of the screw 63 is flush with the surface of the plaster board 64, that is, the screw head floating amount is zero.

FIG. 7(G) is a graph showing the changes over time in the motor current, the motor rotation speed, and the screw head floating amount during the screw tightening operation shown in FIGS. 7(A) to 7(F). A to F in the graph indicate time portions or time ranges corresponding to the states in FIGS. 7(A) to 7(F), respectively. As shown in the graph of FIG. 7(G), the time series data of the actual measured values of the motor current and the motor rotation speed, and the screw head floating amount obtained by an external distance measuring sensor are used in machine learning to generate NN parameters for the trained model 53 shown in FIG. 4. At the design stage of the electric tool 1, by performing operations of fastening various types of screws into various types of mating materials and having the control unit 40 perform machine learning using time series data such as that shown in the graph of FIG. 7(G), NN parameters are generated that can handle various types of screws, various types of mating materials, and whether or not impacting is applied.

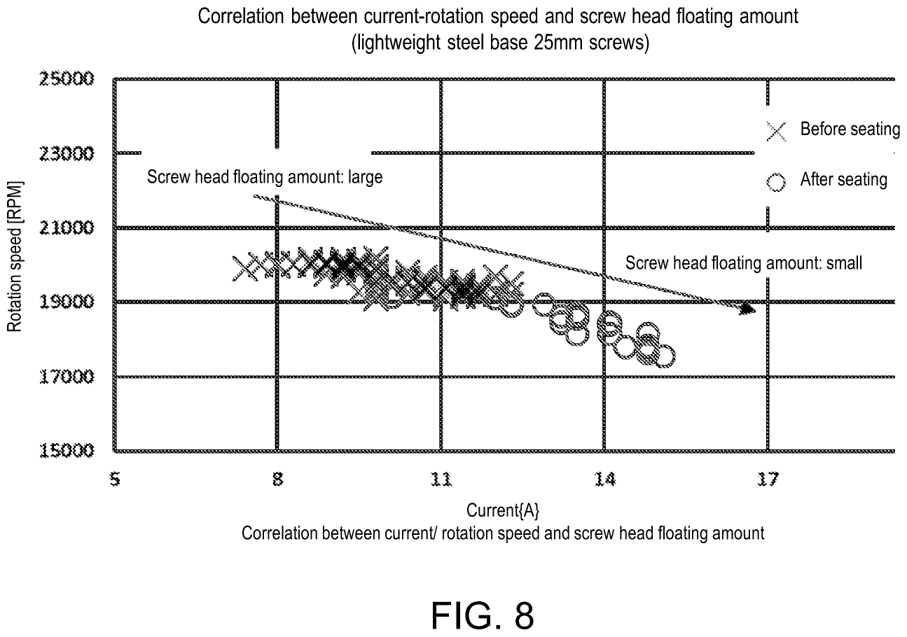

FIG. 8 is a diagram showing the correlation between the current and the rotation speed of the motor 20 in the electric tool 1 and the screw head floating amount. As shown in FIG. 8, there is a positive correlation between the motor rotation speed and the screw head floating amount, whereas there is a negative correlation between the motor current and the screw head floating amount. That is, a correlation was confirmed in which the screw head floating amount is large when the motor current is small and the motor rotation speed is high, and the screw head floating amount is small when the motor current is large and the motor rotation speed is low.

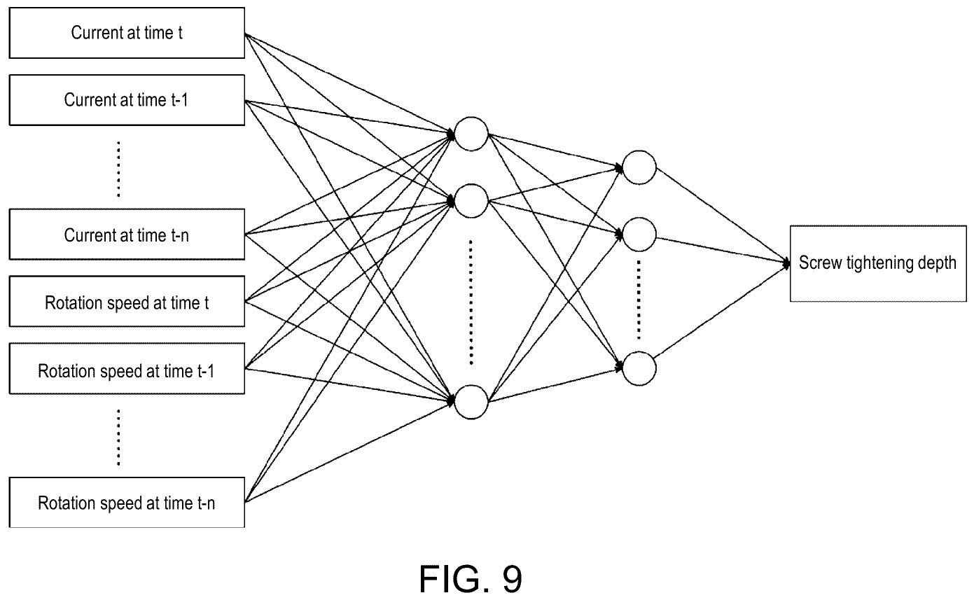

FIG. 9 is a conceptual diagram showing the structure of a neural network that estimates the screw head floating amount in the electric tool 1. As shown in FIG. 8, there is a correlation between the screw head floating amount and the motor current and the motor rotation speed. Using the correlation, as shown in FIG. 9, the screw head floating amount can be estimated by a neural network that inputs a predetermined number of samples of time series data on the motor current and the motor rotation speed and outputs the screw head floating amount. In the embodiment, an actual screw head floating amount is estimated and calculated using the trained model 53 that has been machine-learned using a neural network having the structure shown in FIG. 9.

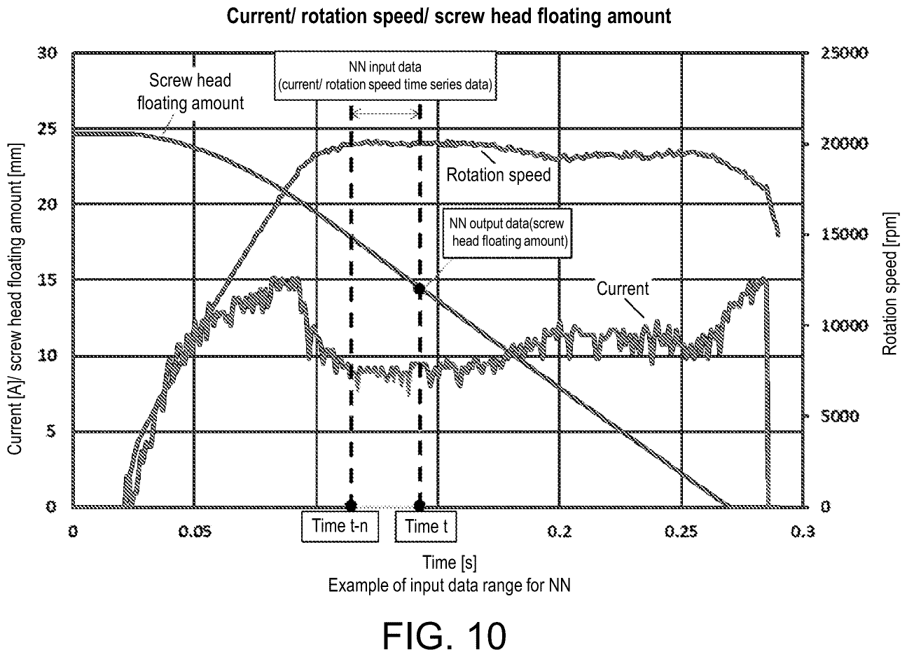

As shown in FIG. 10, the screw head floating amount at time t is estimated using time series data of the motor current and the motor rotation speed from time t−n to time t as input. The length of time from time t−n to time t and the number of time series data are set arbitrarily according to the specifications of the electric tool 1.

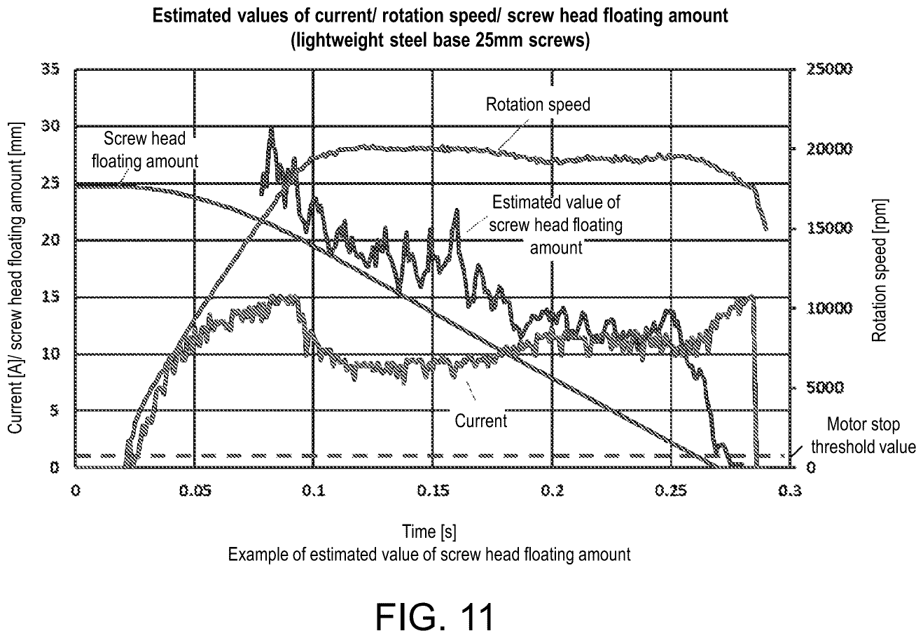

FIG. 11 is a graph in which estimated values of the screw head floating amount are added to the graph of FIG. 10. The estimated value of the screw head floating amount was calculated by inputting actual time series data of the motor current and the motor rotation speed to a trained neural network. The estimated value of the screw head floating amount generally follows the actual measured value of the screw head floating amount. When the estimated value of the screw head floating amount falls below the set threshold value (the “motor stop threshold value” in the figure) (when the estimated value of the screw tightening depth exceeds the set threshold value), by stopping the motor 20 or driving the motor 20 at a low speed, the screw may be automatically stopped when the screw is seated, the screw may be automatically stopped when the screw head floating amount becomes zero, or the screw may be stopped at a predetermined screw head floating amount (predetermined screw tightening depth), etc.

This embodiment provides the following functions and effects.
(1) The control unit 40 can estimate the screw head floating amount according to the measured motor current and motor rotation speed, at any time before or after impacting by the rotary impact mechanism 30 is started during screw tightening operations under a variety of different work conditions. Therefore, by setting a threshold value corresponding to seating, even if the screw is seated before impacting by the rotary impact mechanism 30 is started, the motor 20 can be stopped or decelerated by determining whether the screw is seated or not. The machining amount control mode in the case where the threshold value corresponds to seating corresponds to the seating determination mode.
(2) The control unit 40 determines whether the screw is seated according to the measured motor current and motor rotation speed, so compared to when seating is determined based merely on the motor current, over-tightening and under-tightening can be prevented, improving workability.
(3) The control unit 40 is configured to include a learning model (trained model 53) that estimates the screw tightening depth (screw head floating amount) according to the measured motor current and motor rotation speed, and to stop or decelerate the motor 20 depending on the estimated screw tightening depth and a set setting value (threshold value). Therefore, the screw tightening depth (screw head floating amount) may be estimated with high accuracy using a neural network.
(4) The control unit 40 can estimate the screw tightening depth (screw head floating amount) before the screw is seated. Correspondingly, the threshold setting device 48 is configured to be able to set multiple tightening depths as threshold values (setting values), including a first screw tightening depth (a first screw head floating amount) before the screw is seated on the mating material and a second screw tightening depth different from the first screw tightening depth. Therefore, the motor 20 can be stopped or decelerated at a stage before seating, which can be conveniently used when manually adjusting the screw tightening depth before and after seating, and provides good operability. As the second screw tightening depth, a screw sinking amount (negative screw head floating amount) in which the screw head is seated on the mating material and further sinks into the mating material can also be set, which can ideally meet a variety of work needs.

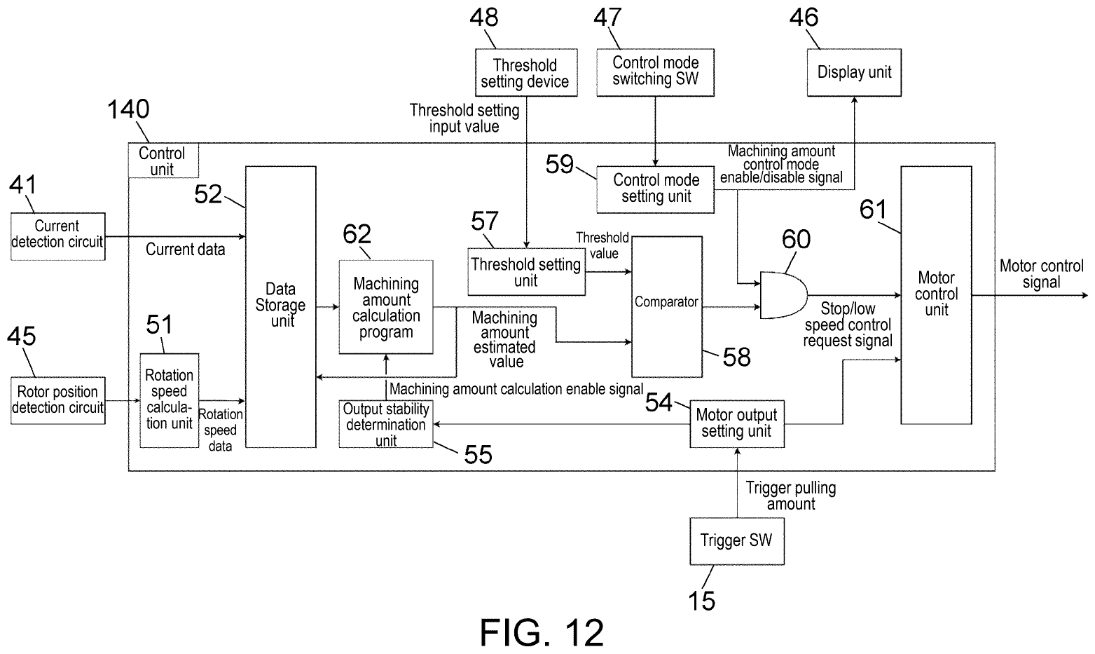

(Second Embodiment) FIGS. 12 to 17 relate to an electric tool according to a second embodiment of the present invention. The electric tool is the same as the electric tool of the first embodiment except for the method of estimating (calculating) the machining amount.

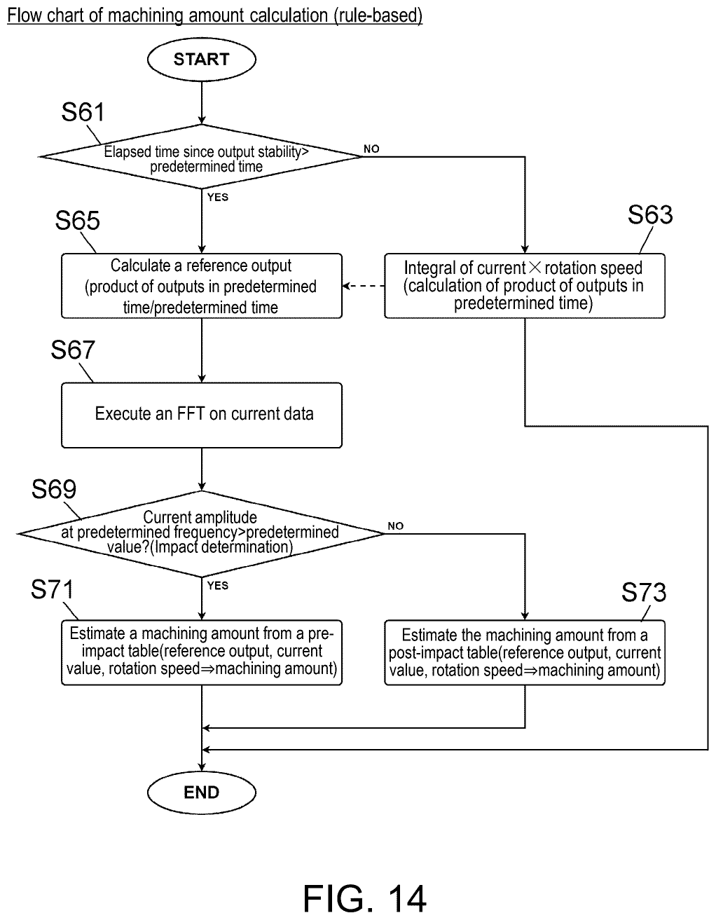

FIG. 12 is a functional block diagram of a control unit 140 of the electric tool according to the second embodiment of the present invention. The control unit 140 is configured such that the trained model 53 and the NN calculation unit 56 of the control unit 40 in FIG. 4 are replaced with a machining amount calculation program 62. Further, the NN calculation enable signal in FIG. 4 is replaced with a machining amount calculation enable signal in FIG. 12, but the function as a signal is the same. The operation of the machining amount calculation program 62 will be described later with reference to FIG. 14.

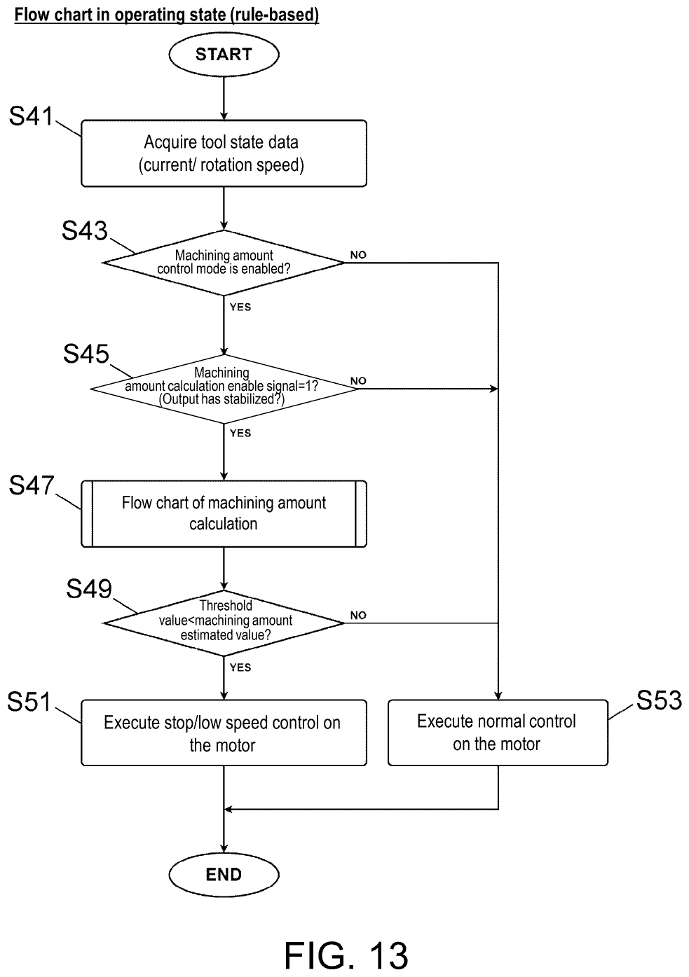

FIG. 13 is a control flow chart of the control unit 140 in the operating state. The control flow chart of the control unit 140 in the stopped state is the same as the control flow chart shown in FIG. 5. The control unit 140 acquires the motor current and the motor rotation speed as the tool state data (S41). When the machining amount control mode is enabled (YES in S43), and the machining amount calculation enable signal is at a high level (YES in S45), the control unit 140 executes the machining amount calculation flow chart shown in FIG. 14 and derives a machining amount calculation value (S47).

When the machining amount calculation value exceeds the threshold value (YES in S49), the control unit 140 performs stop/low speed control on the motor 20 (S51). If the machining amount calculation value does not exceed the threshold value (NO in S49), the control unit 140 performs normal control on the motor 20, that is, controls the rotation speed according to the pulling amount of the trigger switch 15 (S53). If the machining amount control mode is not enabled (NO in S43), or if the machining amount calculation enable signal is at a low level (NO in S45), the control unit 140 performs normal control on the motor 20 (S53).

FIG. 14 is a flow chart of the machining amount calculation in the control unit 140. If the elapsed time since the machining amount calculation enable signal becomes high level (since proceeding to YES in S45) does not exceed a predetermined time (NO in S61), the control unit 140 integrates the motor current×the motor rotation speed (S63). The integral value is used to calculate a reference output in S65, which will be described later.

If the elapsed time since the machining amount calculation enable signal becomes high level (since proceeding to YES in S45) exceeds the predetermined time (YES in S61), the control unit 140 calculates a reference output by dividing the integral value calculated in S63 by the predetermined time (S65). The reference output is used as a criterion value for changing control depending on the combination of the mating material and the screw, that is, for selecting a table to be used in S71 or S73 described later.

The control unit 140 performs FFT (Fast Fourier Transform) processing on measurement data of the motor current. If the amplitude value of a predetermined frequency in the frequency spectrum obtained by FFT exceeds a predetermined value (YES in S69), the control unit 140 determines that impacting is being performed by the rotary impact mechanism 30, and the process proceeds to S71. If the amplitude value of the predetermined frequency in the frequency spectrum obtained by FFT does not exceed the predetermined value (NO in S69), the control unit 140 determines that impacting is not being performed, and the process proceeds to S73. The predetermined frequency at this time is determined by dividing the rotation frequency of the hammer 32 (FIG. 2) calculated from the motor rotation speed by the number of meshing teeth between the hammer 32 and the anvil 33 (FIG. 2).

After performing the impact determination (S69), the control unit 140 derives a calculation value of the screw tightening depth (screw head floating amount) based on the reference output value, the current value, and the rotation speed from a table prepared in advance. In this case, different tables are used depending on whether impacting is being performed or not. That is, when determining that impacting is being performed by the rotary impact mechanism 30 (YES in S69), the control unit 140 derives a calculation value (estimated value) of the screw tightening depth (screw head floating amount) from the reference output, the motor current, and the motor rotation speed based on the pre-impact table (S71). When determining that impacting is being performed by the rotary impact mechanism 30 (NO in S69), the control unit 140 derives a calculation value (estimated value) of the screw tightening depth (screw head floating amount) from the reference output, the motor current, and the motor rotation speed based on the post-impact table (S73).

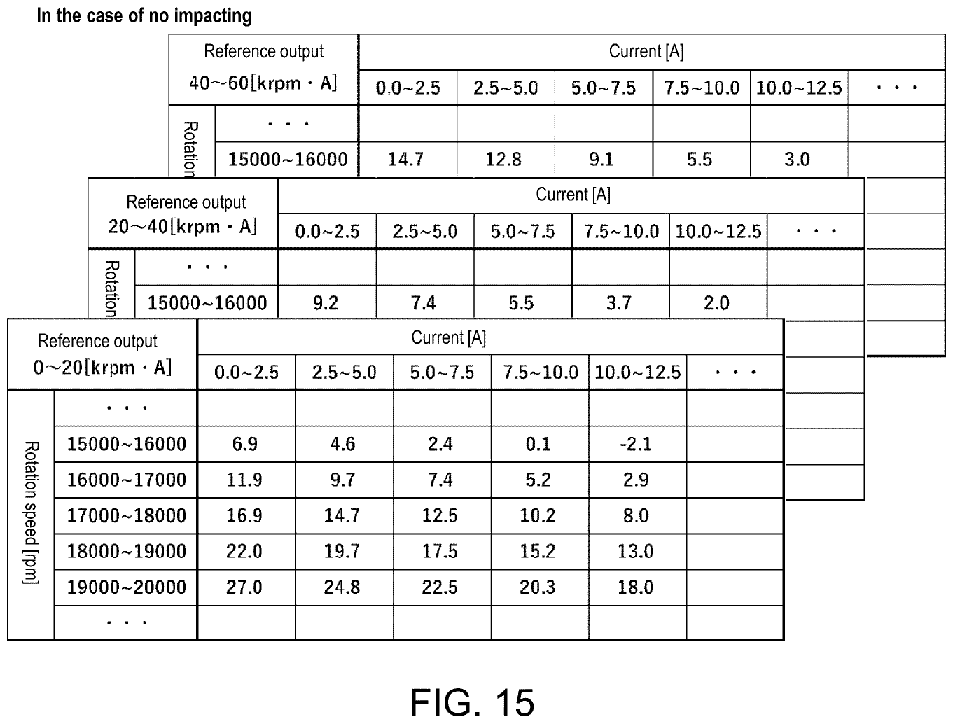

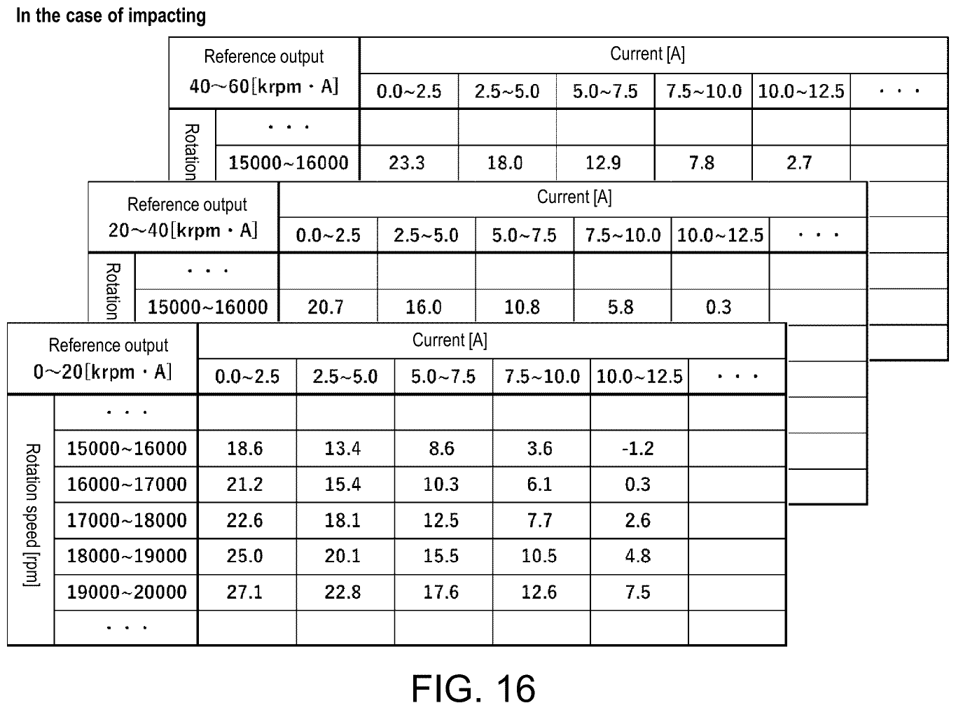

FIG. 15 is a conceptual diagram showing an example of a table used for estimating the machining amount before the start of impacting. FIG. 16 is a conceptual diagram showing an example of a table used for estimating the machining amount after the start of impacting. As shown in the figures, the table is configured as a three-dimensional table in which an estimated value of the screw head floating amount is specified by the reference output, the motor current, and the motor rotation speed.

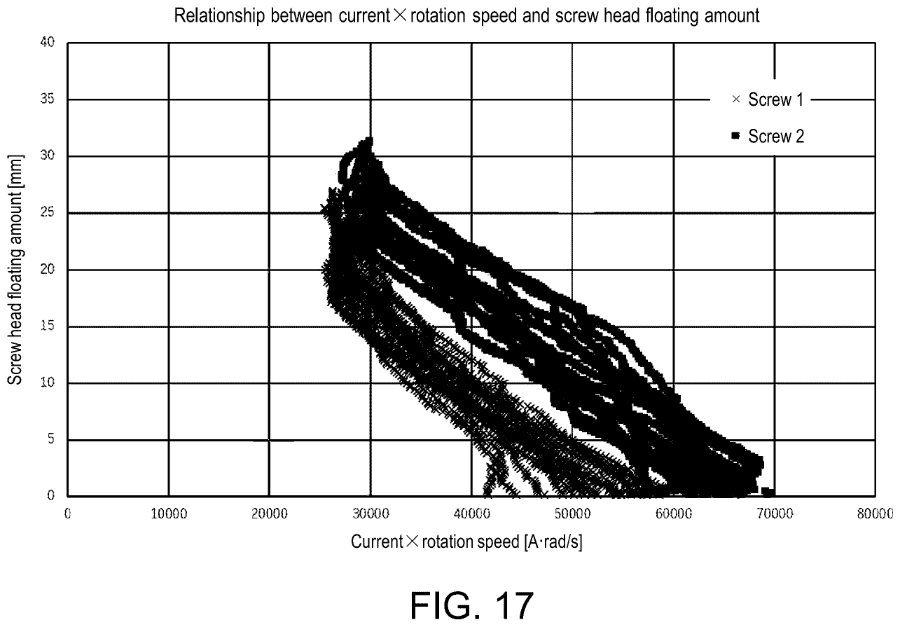

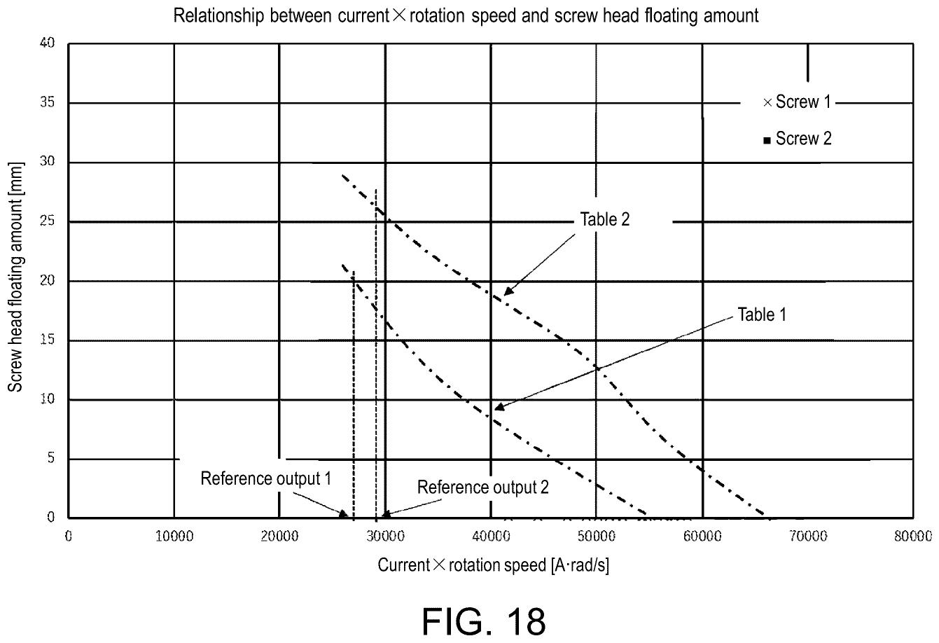

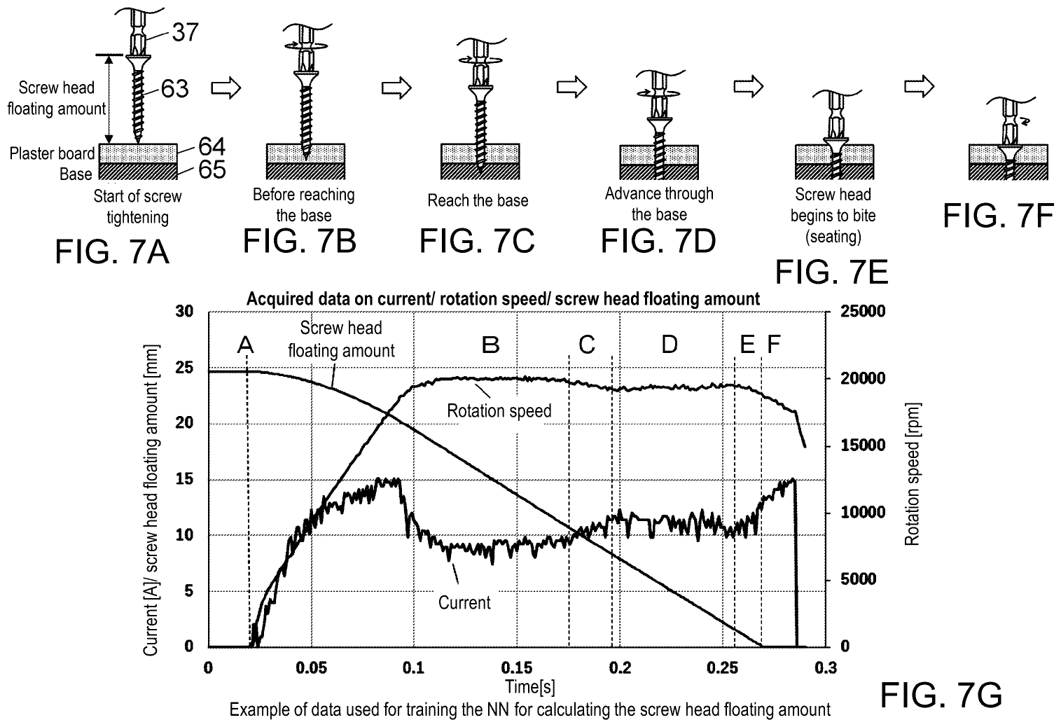

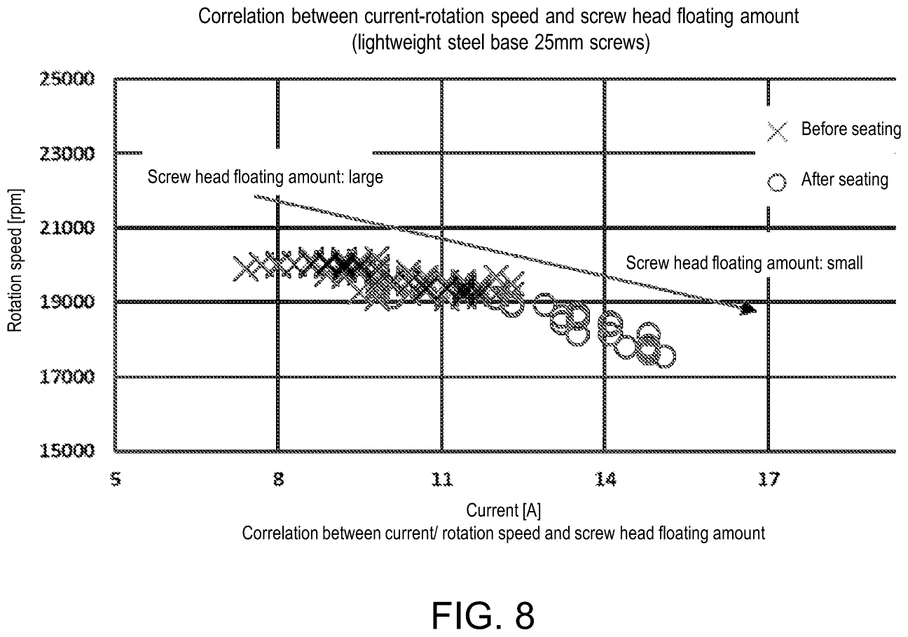

FIG. 17 is a graph showing the relationship between the product of the motor current and the motor rotation speed and the screw head floating amount for two types of screws. The two types of screws are different in length, with screw 2 being longer than screw 1. In the graph of FIG. 17, the relationship between the product of the measured values of the motor current and the motor rotation speed when the two types of screws are tightened 20 times each and the measured value of the screw head floating amount is plotted. FIG. 18 is a graph showing the average curve of the data for the two types of screws in FIG. 17.

In the embodiment, a table to be used for estimating the machining amount, such as that shown in FIG. 17, is generated and stored in advance based on previously acquired actual measurement data of the motor current, the motor rotation speed, and the screw head floating amount. The table is generated so as to have an average curve of data on the screw head floating amount versus the product of the motor current and the motor rotation speed, as shown in FIG. 18. According to the embodiment, when the type of screw or mating material is different, by utilizing the fact that the output (the reference output calculated in S65 of FIG. 14) at the beginning of fastening when the screw head floating amount is large is slightly different, a table that can accommodate various types of screws and various types of mating materials is generated. The embodiment also provides the same or corresponding functions and effects as the first embodiment.

Although the present invention has been described above by using the embodiments as examples, those skilled in the art will understand that various modifications can be made to each component and each processing process of the embodiments within the scope of the claims. A modified example will be described below.

The amount of irreversible machining in the present invention is not limited to the screw tightening depth or the screw head floating amount, and may be, for example, the drilling depth. The electric tool of the present invention is not limited to an impact tool, but may be any other type of tool capable of screwing or drilling, such as a drill driver or an oil pulse tool. Furthermore, the present invention can be applied to all electric tools in which state quantities such as the motor current and the motor rotation speed and time-series data thereof have a correlation with the machining amount.

The time, the motor current, the motor rotation speed, the screw head floating amount, the reference output, etc., given as specific numerical values in the embodiments and drawings do not limit the scope of the invention in any way, and may vary depending on the product specifications.

### Reference Signs List

1: electric tool, 10: housing, 11: motor accommodating unit, 12: handle unit, 13: battery pack mounting unit, 14: tail cover, 15: trigger switch, 16: forward/reverse switching switch, 17: battery pack, 18: hammer case, 19: operation panel, 20: motor, 21: motor shaft, 22: rotor, 23: stator core, 24: stator coil, 25: front insulator, 26: rear insulator, 28: deceleration mechanism, 29: spindle, 30: rotary impact mechanism, 31: spring, 32: hammer, 33: anvil, 34: fan, 35: first control board, 36: second control board, 37: bit, 38: inverter circuit, 39: resistor, 40: control unit, 41: current detection circuit, 42: battery voltage detection circuit, 43: control power supply circuit, 44: control power voltage detection circuit, 45: rotor position detection circuit, 46: display unit, 47: control mode switching switch, 48: threshold setting device (setting unit), 49: drive signal output circuit, 50: magnetic sensor, 51: rotation speed calculation unit, 52: data storage unit, 53: trained model, 54: motor output setting unit, 55: output stability determination unit, 56: NN calculation unit, 57: threshold setting unit, 58: comparator, 59: control mode setting unit, 60: AND gate, 61: motor control unit, 62: machining amount calculation program, 63: screw, 64: plaster board, 65: base.

1. An impact tool, comprising:
a motor;
an impact mechanism, driven by the motor;
a current measuring circuit for measuring a current of the motor;
a rotation speed measuring circuit for detecting a rotation speed of the motor; and
a control unit, controlling the motor, wherein
the control unit comprises a seating determination mode configured to determine whether a screw is seated, in accordance with the current of the motor and the rotation speed of the motor that are measured, at any time point before or after impacting by the impact mechanism is started in a screw tightening operation having a plurality of different work conditions, and to stop or decelerate the motor after it has been determined that the screw is seated, and
in the seating determination mode, the control unit is configured
to determine that the screw is seated when the current of the motor and the rotation speed of the motor reach a first value and a second value, respectively, before the impacting is started, in the screw tightening operation under a first work condition, and
to determine that the screw is seated when the current of the motor and the rotation speed of the motor reach a third value and a fourth value different from the first value and the second value, respectively, after the impacting is started, in the screw tightening operation under a second work condition different from the first work condition.

2. (canceled)

3. The impact tool according to claim 1, wherein
the control unit is configured to comprise a learning model that estimates a screw tightening depth according to the current of the motor and the rotation speed of the motor that are measured, and to stop or decelerate the motor depending on the screw tightening depth estimated and a set setting value.

4. An electric tool, comprising:
a motor; and
a control unit, controlling the motor, wherein
the control unit comprises a screw tightening depth control mode configured to estimate a screw tightening depth into a mating material according to a measured state quantity of the motor, and to control the motor according to the screw tightening depth estimated and a setting value set by a setting unit,
the setting unit is configured to be able to set a plurality of screw tightening depths, including a first screw tightening depth before a screw is seated on a mating material and a second screw tightening depth different from the first screw tightening depth, as the setting values.

5. The electric tool according to claim 4, wherein
the screw tightening depth is a screw floating amount, which is a distance between a screw head and the mating material, or a screw sinking amount, which is an amount of the screw head that is seated on the mating material and further sinks into the mating material.

6. The electric tool according to claim 4, wherein
the second screw tightening depth is a screw tightening depth after the screw is seated on the mating material.

7. The electric tool according to claim 4, wherein
the control unit is configured to comprise a learning model that estimates a screw tightening depth into a mating material according to a measured state quantity of the electric tool, and to stop or decelerate the motor according to the screw tightening depth estimated and a setting value set by a setting unit.

8. (canceled)

9. (canceled)

10. (canceled)

11. An impact tool, comprising:
a motor;
an impact mechanism, driven by the motor; and
a control unit, controlling the motor, wherein
the control unit comprises a seating determination mode which determines whether a wood screw is seated on a mating material during a wood screw fastening operation involving drilling in the mating material, and
in the seating determination mode, the control unit is configured
to execute, before impacting by the impact mechanism is started, a first control which determines whether a wood screw that involves drilling is seated based on a state quantity of the motor before impacting is started, and to stop or decelerate the motor after it has been determined that the wood screw is seated, and
to execute, after impacting by the impact mechanism is started, a second control different from the first control which determines whether a wood screw that involves drilling is seated based on a state quantity of the motor after impacting is started, and to stop or decelerate the motor after it has been determined that the wood screw is seated.
